(19) United States
(12) Patent Application Publication
(10) Pub. No.: US 2007/0187015 A1
(43) Pub. Date: Aug. 16, 2007

(54) Assembly including a wheel and a tire comprising passive deflation means, pressure regulating system, wheel, tire and pressure regulating process

(75) Inventor: Denis Alff, Malauzat (FR)

Correspondence Address: COHEN PONTANI LIEBERMAN & PAVANE LLP, Suite 1210, 551 Fifth Avenue, New York, NY, 10176, US

(73) Assignee: Michelin Recherche et Technique S.A., Granges-Paccot (CH)

(21) Appl. No.: 11/648,286

(22) Filed: Dec. 28, 2006

(30) Foreign Application Priority Data
Jan. 6, 2006 (FR) 06/00173

(51) Int. Cl. B60C 23/10

(52) U.S. Cl. 152/418

(57) ABSTRACT

Assembly (10) including a wheel (12) and a tire (14), wherein the assembly comprises passive deflation means (20) for the tire (14). These means may be a porous zone of the tire or of the wheel, and may also comprise a deflation valve which is inactive below a predetermined pressure threshold.

### FIELD OF THE INVENTION

The present invention relates to an assembly including a wheel and a tire, a system for regulating the pressure of a tire, a wheel, a tire and a process for regulating the air pressure of a tire.

### BACKGROUND OF THE INVENTION

A system for regulating the pressure of a tire of the type comprising means for inflating and means for deflating the tire is known from the prior art.

This regulating system also comprises first and second means for controlling the inflation means and the deflation means respectively. The pressure of the tire is regulated by actuating the first and second control means.

Document GB 2 324 511 discloses an assembly consisting of a wheel and a tire comprising passive deflation means inactive below a predetermined pressure threshold of the tire and active above this threshold, wherein the predetermined threshold is all excessive inflation pressure. The threshold is such that above it, the tire will deliver less than optimum performance.

### SUMMARY OF THE INVENTION

One object of the invention is to simplify the control of the means for inflating and deflating the tire.

To this end, one aspect of the invention is directed to an assembly including a wheel and a tire, comprising passive deflation means for the tire inactive below a predetermined pressure threshold of the tire and active above this threshold. The predetermined threshold is less than or equal to a recommended inflation pressure of the tire. For example, the recommended inflation pressure corresponds to use of the tire on an automobile travelling without passengers and in urban driving conditions.

The passive deflation means ensure intentional evacuation of air from the tire to the outside.

Since the deflation means are passive, they do not need to be controlled by specific control means.

The invention thus makes it possible to simplify the control of the means for inflating and deflating the tire.

An assembly according to an embodiment of the invention may furthermore comprise one or more of the following characteristics:

The passive deflation means comprise a porous zone of the assembly. The porous zone may be borne by the tire or by the wheel. In particular, it is advantageous for the porous zone to be borne by the rim of the wheel.

It is conventional to manufacture an aluminium wheel using a low-pressure moulding process. In order to avoid a lack of airtightness due to the relative porosity of aluminium, an aluminium wheel generally comprises, in the prior art, relatively thick walls.

In an embodiment of the invention, it is tolerated that some zones of the walls of the wheel are porous and form the passive deflation means. Thus it is possible to reduce the thickness of the walls of the wheel compared with the prior art, which makes it possible to reduce the mass of the wheel and to reduce the cost of manufacture thereof. The porous zone may also be obtained by means of micro-grooves or striations formed in the rim of the wheel.

The recommended inflation pressure is an inflation pressure when hot.

The recommended inflation pressure is an inflation pressure when cold.

The predetermined threshold is less by several tenths of a bar than the recommended inflation pressure.

The passive deflation means comprise a deflation valve borne by the assembly. When designing the deflation valve, its threshold activation pressure and its flow rate can be very easily specified.

When the deflation valve is open, the flow rate of the deflation valve is greater than 0.5 litres of air per day.

When the deflation valve is open and the pressure in the tire is equal to the predetermined pressure threshold, the flow rate of the deflation valve is less than 20 litres of air per day.

The deflation valve is borne by the wheel at the location conventionally reserved for affixing an inflation valve. Thus it is possible to use a standard wheel.

The deflation valve is borne at the centre of the wheel.

The assembly furthermore comprises an inflation valve inserted into an air supply circuit for the tire, the inflation and deflation valves being integrated in a single device borne by the wheel. Due to this characteristic, it is necessary to provide only a single bore in the wheel during manufacture.

The assembly comprises a device permitting travelling on a flat tire, for example a bearing support.

Another aspect of the invention is a system for regulating the pressure of a tire, of the type comprising means for inflating and means for deflating a tire, which has an assembly including a wheel and a tire as previously defined, and the deflation means of the system are formed by the passive deflation means of the assembly.

This pressure regulating system is particularly simple since only the inflation means for the system need to be controlled.

Advantageously, the inflation means comprise a pressurised air source capable of producing a flow rate of pressurised air greater than the flow rate of the passive deflation means.

Preferably the ratio between the flow rate of the air source and the flow rate of the passive deflation means is greater than 10.

Another aspect of the invention is a wheel intended to form part of an assembly such as previously defined, and which comprises the passive deflation means.

Another aspect of the invention is a tire intended to form part of an assembly such as previously defined, and which comprises the passive deflation means.

As the deflation means are passive and are not controlled, they are permanently active. Thus, these passive deflation means permit permanent evacuation of air. However, as the rate of evacuation of air is calibrated and relatively low, it is possible for all that to increase the pressure of the tire by controlling the inflation means so that they cause air to enter the a tire at a higher flow rate than the calibrated deflation flow rate.

In order to reduce the pressure of the tire, it is enough simply to deactivate the inflation means and allow the air to escape from the tire due to the passive deflation means.

### BRIEF DESCRIPTION OF THE DRAWINGS

FIG. 1 is a diagram of a system for regulating the pressure of the tires of an automobile according to the invention,

FIG. 2 is a diagram of a first embodiment of passive deflation means according to the invention integrated in the system shown in FIG. 1,

FIG. 3 is a diagram of a second embodiment of passive deflation means according to the invention.

FIGS. 4 and 5 are views in section of a wheel comprising the passive deflation means depicted in FIG. 3, and

FIG. 6 depicts a view in section of a wheel comprising the passive deflation means shown in FIG. 2.

### DETAILED DESCRIPTION OF THE DRAWINGS

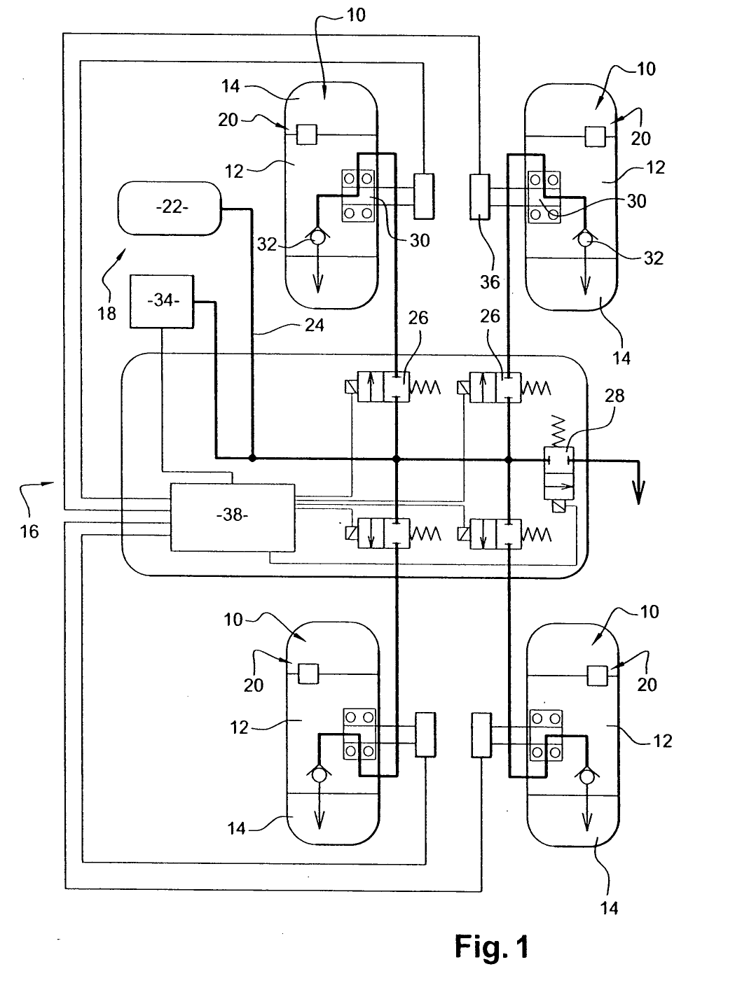

Four assemblies 10 consisting of a wheel 12 and a tire 14 of an automobile are shown diagrammatically in FIG. 1.

The pressure of the tires 14 is regulated by a pressure regulating system 16 according to the invention.

The pressure regulating system 16 comprises means 18 for inflating and means 20 for deflating the tires 14.

The inflation means 18 comprise an air source 22 formed for example by a compressor, an air supply circuit 24 for the tires 14, solenoid valves 26 inserted into the supply circuit 24 between each tire 14 and the air source 22, and, optionally, an exhaust solenoid valve 28.

The supply circuit 24 connects the air source 22 to each of the tires 14 by means of rotary joints, for example air passage bearings 30 borne by each wheel. The supply circuit 24 furthermore comprises unidirectional inflation valves 32 which allow air to pass into the supply circuit only from the air source 22 to the tire 14. The inflation valves 32 are in the open position when the pressure in the supply circuit 24 is greater than the pressure in the tire 14. The valve 32 is a passive valve of very simple and inexpensive design.

The pressure of the tires 14 is measured by means of a pressure sensor 34 arranged so as to measure the pressure in the supply circuit 24. The pressure of the tires can also be measured indirectly by means of sensors 36 for the speed of rotation of the wheels 12.

The sensors 36, the solenoid valves 26 and the pressure sensor 34 are connected to a computing means 38 capable of determining the pressure of the tires 14.

The measurement of pressure of the tires is not the subject of this application and may be carried out by any known means.

The deflation means 20 of the system for regulating the pressure of the tires 14 are passive deflation means. In other words, these passive deflation means 20 ensure intentional evacuation of air from the tire 14 to the outside.

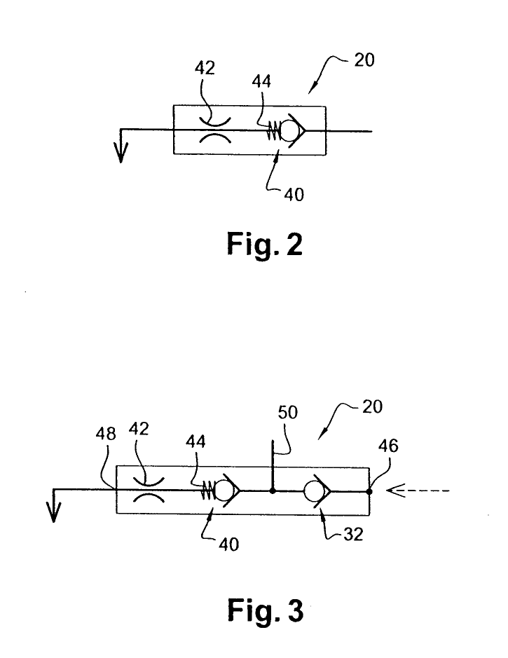

The passive deflation means 20 of the tires will be described in greater detail with reference to FIGS. 2 to 6.

According to a first embodiment of the passive deflation means 20 of the tire 14, the means 20 are attached to the assembly 10. These means 20 are illustrated diagrammatically in FIG. 2 and comprise a deflation valve 40 and a flow limiting device 42. The respective positions of the flow limiting device 42 and the deflation valve 40 are immaterial. FIG. 2 illustrates the case in which the deflation valve 40 is arranged upstream of the flow limiting device 42; the converse is also entirely possible.

The passive deflation means 20 of the tire 14 permit air to pass only from the inside of the tire 14 to the outside of the tire, that is to say they only permit evacuation of air.

The flow rate of the passive deflation means 20 is very much less than the inflation flow rate permitted by the inflation means 18 of the regulating system 16. The ratio between the two flow rates (inflation/deflation) is at minimum 10 and may be far greater than 10 in order to limit the time necessary for inflation.

The deflation flow rate is calibrated using the flow limiting device 42. If it is desired to have a very low calibrated flow rate, the flow limiting device 42 may advantageously be replaced by a permeable membrane. The flow rate of the membrane is a function of its surface area.

The means 20 furthermore comprise a spring 44 for calibrating the opening of the valve 40. Due to this spring 44, the passive deflation means 20 are inactive below a predetermined pressure threshold of the tire 14 and are active above this threshold, the threshold being able to be changed by modifying the characteristics of the spring 44.

The predetermined threshold is less than or equal to a recommended inflation pressure of the tire. Since the pressure in the tires is kept greater than or equal to this recommended value, this means that the deflation is then permanent.

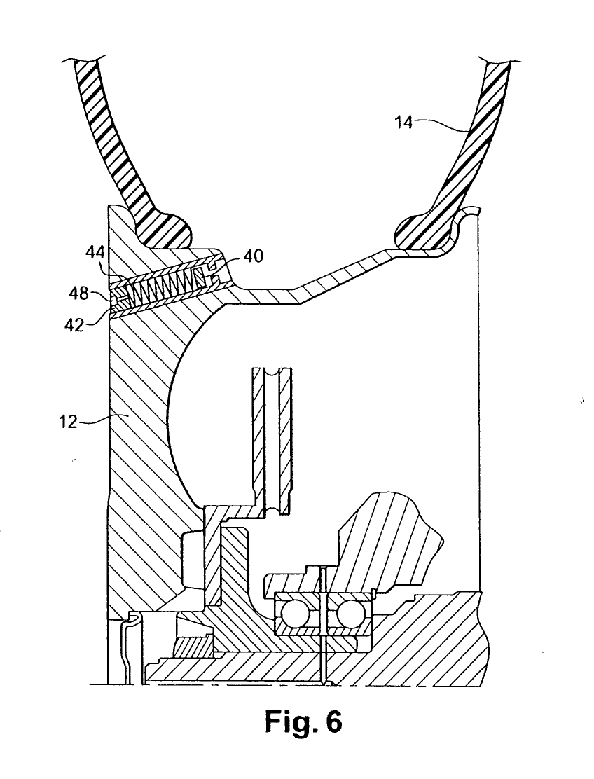

According to a first variant shown in FIG. 6, the passive deflation means 40, 42 and 44 are positioned on the wheel 12, for example instead of the inflation valve, which is now superfluous owing to the regulating system 16.

According to a second variant (not shown), the deflation means 20 of FIG. 2 are integrated on the tire 14 instead of being integrated on the wheel 12.

According to a third preferred variant shown in FIGS. 3 to 5, the passive deflation means 20 of the tire 14 comprise both the deflation valve 40 intended to provide fluidic communication between the interior of the tire 14 and the surrounding air, and the inflation valve 32 intended to provide fluidic communication between the air supply circuit 24 and the interior of the tire 14.

As shown in FIG. 3, the passive deflation means 20 according to the third variant of the first embodiment comprise a connector 46 to the air supply circuit 24, an outlet 48 to the external air and an outlet 50 to the inside of the tire 14.

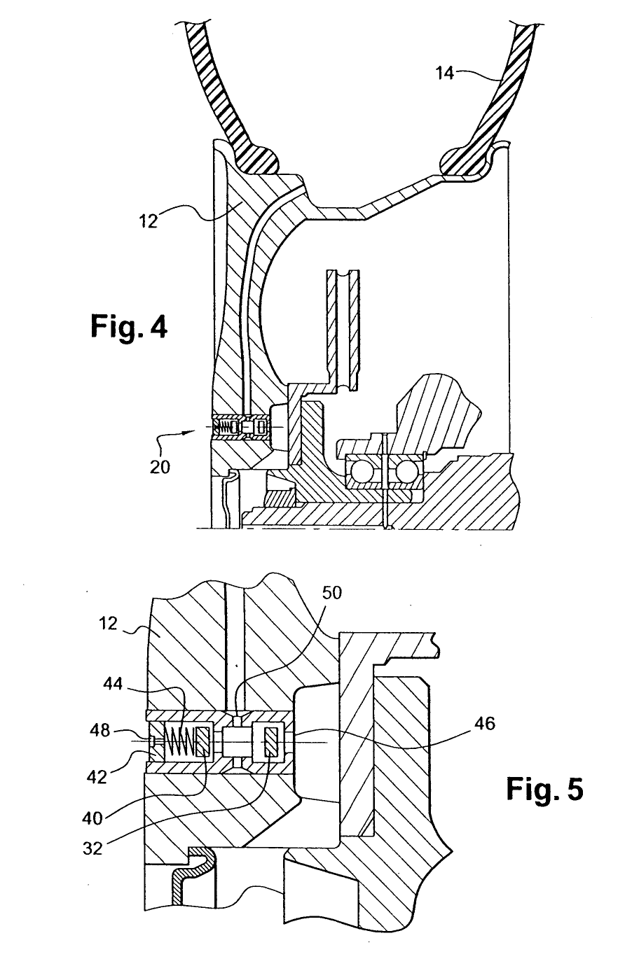

FIG. 4 is an axial section through an assembly consisting of a wheel 12 and a tire 14 comprising passive deflation means 20 of the tire according to the third variant of the first embodiment. FIG. 5 is a section identical to FIG. 4, showing the means 20 in greater detail.

This third variant is particularly advantageous insofar as the wheel 12 is particularly simple to manufacture. This is because, given that the deflation valve 40 and the inflation valve 32 are combined in a single device, it is necessary to design only one location in the wheel 12 to accommodate both valves. In particular, if the wheel 12 is manufactured by moulding, the orifice intended to accommodate the two valves is obtained by means of an insert arranged within the mould. Given that the orifice passes through the wheel 12 over its entire thickness, the insert may be easily removed from the wheel on emerging from the mould, via the outside of the wheel.

According to a second embodiment of the passive deflation means 20 of the tire 14, the means 20 comprise a porous zone of the assembly, that is to say a zone of the assembly which is not airtight and which allows air to pass from the inside of the tire to the outside at a calibrated flow rate.

According to a first variant (not shown), the porous zone is borne by the wheel, preferably by a rim of the wheel.

According to a second variant (not shown), the porous zone is formed on the tire.

The pressure regulating system 16 which has just been described permits regulation of the air pressure in the tires 14 by implementing the process of the invention.

To inflate a tire, the inflation means 18 is activated and the solenoid valve 26 of the tire which it is desired to inflate is opened.

The operation of the passive deflation means 20 of the tire 14 in different cases will be described below, making the following assumptions.

An automobile having a life of ten years is considered. This vehicle comprises a compressor used for a function other than regulating the pressure of the tires, for example for air suspensions. This compressor has a flow rate of 25 litres per minute at the desired pressure and a life of 500 hours. The volume of a tire 10 of this automobile is 30 litres. Finally, during normal travel, the recommended low pressure of the tire is 2.3 bar and the recommended high pressure when the vehicle is under load or when it is travelling on a motorway is 2.6 bar. The pressure values mentioned above are values recommended for a hot tire.

To increase the pressure of the tire 14 from the recommended low inflation pressure to the recommended high inflation pressure, the inflation means 18 of the tire 14 of the pressure regulating system 16 according to the invention are activated, at a flow rate greater than the flow rate of the passive deflation means 20. The tire is therefore supplied with air by means of the pressurised air source 22 as described previously.

To reduce the pressure of the tire 14 from the recommended high pressure to the recommended low pressure, the inflation means 18 are deactivated completely.

To keep the pressure of the tire 14 around a recommended inflation pressure, the inflation means 18 are activated regularly as a function of the pressure measurements of the tires, with a frequency and duration which depend on the flow rate of the deflation means and of the desired accuracy of regulation.

In the following examples, it will be assumed that over the ten years of life of the automobile it will travel for 4,500 hours. Furthermore, it will be assumed that the vehicle travels on motorways or under load for 50% of the time.

The process of deflating the tire of an assembly comprising passive deflation means 20 according to the first embodiment, that is to say comprising an attached calibrated valve 40, is as follows.

In a first case, the valve 40 is calibrated so that it permits a flow rate of 510 litres per month, or 17 litres per day, at the pressure at which it is activated. Furthermore, the valve 40 is designed such that it is in the closed position when the pressure of the tire 14 is less than the recommended low inflation pressure of the tire 14 when hot, that is to say below 2.3 bar.

In this case, the pressure of the tire 14 is kept at around the recommended low pressure during normal travel. Consequently, during normal travel it is not necessary to adjust the pressure of the tire using the regulating system 16. Under specific conditions, for example when travelling on a motorway or when the vehicle is under load, the tire 14 is inflated such that its pressure when hot changes to 2.6 bar.

Keeping the pressure of the four tires at the recommended high pressure requires for example 14 seconds' inflation every two hours. Thus, the volume of air necessary to compensate for the deflation when the tire 14 is at the recommended high pressure during the life of the vehicle is 1,800 litres of air per tire, or approximately 8,000 litres of air for the vehicle, taking into account the different losses of the regulating system.

Assuming that the compressor already present on the vehicle, initially dedicated to a different function from the inflation of the tire, is used, it will therefore be used for approximately 5 hours and 20 minutes, or 1% of its life. It is therefore entirely possible to use part of the availability of this compressor for inflating the tires.

Owing to the calibrated flow rate of 17 litres per day, the pressure of a tire goes from the recommended high pressure to the recommended low pressure in approximately 12 hours.

According to a second conceivable case, the calibrated flow rate of the valve 40 is also 17 litres per day. On the other hand, the predetermined pressure threshold of the tire below which the valve is closed is less by a few tenths of a bar than the recommended minimum inflation pressure. For example, this threshold is set at 1.9 bar.

In this case, it is necessary to actuate the inflation means 18 regularly, even during normal travel, that is to say urban driving when not under load.

In this case, and unlike the previous case, following a prolonged period of standing of the automobile, it is necessary to inflate the tires 14 to return them to the recommended low pressure. This is because, when standing for prolonged periods, the tires cool and the passive deflation means deflate the tire to the set threshold.

It should be noted that the cooling of the tire has a more rapid effect on the lowering of the pressure of the tire than the deflation means. Once the tire is cold, only the deflation means have an effect on the pressure of the tire. This aspect is particularly advantageous because the drop in pressure linked to the cooling of a tire (approximately 0.3 bar) will be effective shortly after stopping and the losses of compressed air will then be limited. The cold tire after prolonged stoppage will be at 1.9 bar, will return to a pressure of 2.2 bar during travel and will require only 0.1 bar make-up inflation.

In this specific case, the volume of air necessary to compensate for the leakage during travel over ten years is 3,600 litres per tire, or approximately 16,000 litres of air for the whole of the vehicle, taking into account the different losses of the system. It is therefore possible to use the compressor already present on the vehicle for approximately 10 hours and 40 minutes, or approximately 2% of its life.

The fact that the valve 40 is calibrated so as to close below a threshold less than the recommended low pressure enables different recommended low pressures to be used between the two axles of the vehicle while using only a single type of deflation valve. This also makes it possible better to manage the manufacturing and operating tolerances of the deflation valve.

Due lo the knowledge of the flow rate of the deflation valve, it is possible to detect leaks from the tire due to a puncture. This is because it is possible to detect such leaks by comparing the frequency of activation of the inflation means and the known flow rate of the deflation valve. Likewise, when starting the vehicle, a pressure measurement less than a predetermined threshold will make it possible to detect an abnormal leak (and the flow rate thereof as a function of the stoppage time).

The process of deflating the tire of an assembly comprising passive deflation means according lo the second embodiment, that is to say in which the assembly consisting of the wheel and the tire comprises a porous zone, is as follows.

In a first case, the porous zone permits deflation of the tire at a low flow rate of 15 litres per month, or 0.5 litres per day.

In this case, owing to the fact that the deflation means are active whatever the pressure of the tire, the latter, during a prolonged period of standing, may deflate totally.

Taking into account the different assumptions made previously, the volume of air necessary to compensate for the permanent leak created by the porous zone for ten years is 1,800 litres per tire, or approximately 8,000 litres for the whole of the vehicle.

It is therefore possible to use the compressor already present on the automobile for approximately 5 hours and 30 minutes, that is to say 1% of its life. It is in fact sufficient, in order to keep the pressure of the tire at the recommended low pressure, to inflate it for approximately 14 seconds every three days.

To go from the recommended high pressure to the recommended low pressure takes approximately 17 days.

In a second case, the calibrated flow rate of the porous zone is a high flow rate of 510 litres per month, or 17 litres per day. In this case, the time to go from recommended high pressure to the recommended low pressure is 12 hours, which relatively speaking permits more precise and more rapid regulation of the pressure.

However, the volume of air necessary to compensate for this permanent leak for ten years is 30,000 litres per tire, or approximately 270,000 litres for the vehicle, which requires using the compressor already present on the vehicle for approximately 180 hours, or 33% of the life of the compressor. In such a case, preferably a second compressor adapted for this requirement will be added to the vehicle.

Owing to the invention, the system for regulating the pressure of the tire is relatively simple since it is capable of using an air source already present on the automobile. The deflation function is provided by the inexpensive passive deflation means of the tire.

Finally, it will be noted that the invention is not limited to the embodiments which have just been described.

In fact, it is possible to implement the invention on tires which permit travelling on a flat tire. The volume of a tire which permits travelling on a flat tire is relatively speaking smaller than the volume of a conventional tire, so that the inflation and deflation times are reduced. Furthermore, with such tires, it is possible to start more rapidly after a long time standing, without waiting for the tires to be inflated to the recommended pressure.

1. An assembly (10) including a wheel (12) and a tire (14), wherein the assembly comprises passive deflation means (20) for the tire (14), in which the passive deflation means (20) are inactive below a predetermined pressure threshold of the tire (14) and are active above this threshold, wherein the predetermined threshold is less than or equal to a recommended inflation pressure of the tire (14).

2. The assembly (10) according to claim 1, in which the passive deflation means (20) comprise a porous zone of the assembly (10).

3. The assembly (10) according to claim 1, in which the recommended inflation pressure is an inflation pressure when hot.

4. The assembly (10) according to claim 1, in which the recommended inflation pressure is an inflation pressure when cold.

5. The assembly (10) according to claim 4, in which the predetermined threshold is less by several tenths of a bar than the recommended inflation pressure.

6. The assembly (10) according to claim 4, in which the passive deflation means (20) comprise a deflation valve (40) borne by the assembly (10).

7. The assembly (10) according to claim 6, in which, when the deflation valve (40) is open, the flow rate of the deflation valve (40) is greater than 0.5 litres of air per day.

8. The assembly (10) according to claim 6, in which, when the deflation valve (40) is open and the pressure in the tire (14) is equal to the predetermined threshold, the flow rate of the deflation valve (40) is less than 20 litres of air per day.

9. The assembly (10) according to claim 6, in which the deflation valve (40) is borne by the wheel (12) in the location conventionally reserved for affixing an inflation valve.

10. The assembly (10) according to claim 6, in which the deflation valve (40) is borne in the central zone of the wheel (12).

11. The assembly (10) according to claim 6, furthermore comprising an inflation valve (32) inserted into an air supply circuit (24) for the tire (14), the inflation (32) and deflation (40) valves being integrated in a single device borne by the wheel (12).

12. The assembly (10) according to claim 1, comprising a device which permits travelling on a flat tire, for example a bearing support.

13. A system (16) for regulating the pressure of a tire (14), of the type comprising means (18) for inflating and means (20) for deflating the tire (14), wherein the system comprises an assembly (10) including a wheel (12) and a tire (14) according to claim 1, and in that the deflation means (20) of the system are formed by the passive deflation means (20) of the assembly.

14. The system (16) according to claim 13, in which the inflation means (18) comprise a pressurised air source (22) capable of producing a flow rate of air greater than the flow rate of the passive deflation means (20).

15. The system (16) according to claim 14, in which the ratio between the flow rate of the air source (12) and the flow rate of the passive deflation means (20) is greater than 10.

16. A wheel (12) adapted to form part of an assembly (10) according to claim 1, wherein the wheel comprises the passive deflation means (20).

17. A tire (14) adapted to form part of an assembly (10) according to claim 1, wherein the tire comprises the passive deflation means (20).

18. The assembly (10) according to claim 3, in which the predetermined threshold is less by several tenths of a bar than the recommended inflation pressure.
